(19) United States
(12) Patent Application Publication
(10) Pub. No.: US 2025/0051140 A1
(43) Pub. Date: Feb. 13, 2025

(54) SYSTEM FOR DETECTING BROKEN COMBPLATE TEETH OF AN ESCALATOR

(71) Applicant: Otis Elevator Company, Farmington, CT (US)

(72) Inventor: Bruno Henrique Torres, São Paulo (BR)

(21) Appl. No.: 18/447,494

(22) Filed: Aug. 10, 2023

(51) Int. Cl. B66B 25/00; B66B 27/00

(52) U.S. Cl. CPC B66B 25/003; B66B 25/006; B66B 27/00

(57) ABSTRACT

An escalator system is provided and includes a combplate including teeth, a moving step including grooves and being drivable to pass by the combplate at a step-combplate interface at which, when each tooth is correctly positioned, each tooth passes through a corresponding groove and a detection system. The detection system includes an emitter and receiver pair and is configured to determine whether a signal pattern, which is derived from communications of the emitter and receiver pair and which is partially reflective of conditions of the teeth, is indicative of at least one tooth being incorrectly positioned.

### BACKGROUND

The present disclosure relates to escalator systems and, in particular, to a system and method for detecting broken combplate teeth of an escalator.

Conveyors of people, such as escalators and moving walkways, usually include a conveyance band that moves with people standing on it between opposing landing zones, driving machines that drive movement of the conveyance band and combplate. The conveyance band extends and moves between the opposing landing zones and has a surface that often includes cleats and grooves. The combplates are provided at the opposing landing zones. Each combplate includes teeth that extend into the grooves of the surface of the conveyance band as the conveyance band moves relative to each combplate and the cleats move along each of the teeth. A broken tooth of the combplate can degrade performance of the combplate and the escalator as a whole.

Therefore, a need exists for a system and method that provide for traffic monitoring and entrapment detection for a combplate to allow for reliable detection of entrapment incidents.

### SUMMARY

According to an aspect of the disclosure, an escalator system is provided and includes a combplate including teeth, a moving step including grooves and being drivable to pass by the combplate at a step-combplate interface at which, when each tooth is correctly positioned, each tooth passes through a corresponding groove and a detection system. The detection system includes an emitter and receiver pair and is configured to determine whether a signal pattern, which is derived from communications of the emitter and receiver pair and which is partially reflective of conditions of the teeth, is indicative of at least one tooth being incorrectly positioned.

In accordance with additional or alternative embodiments, the signal pattern is a sonic pattern.

In accordance with additional or alternative embodiments, the emitter and receiver pair includes an emitter and a receiver arranged proximate to a plane of the step-combplate interface.

In accordance with additional or alternative embodiments, the emitter and receiver pair includes an ultrasonic emitter.

In accordance with additional or alternative embodiments, the emitter and receiver pair includes an emitter and a receiver respectively connected to outermost teeth of the combplate.

In accordance with additional or alternative embodiments, at least one of a frequency, an amplitude and a shape of the signal pattern is indicative of the at least one tooth being incorrectly positioned.

In accordance with additional or alternative embodiments, the detection system is further configured to determine whether the signal pattern is one of indicative of the at least one tooth being incorrectly positioned such that the combplate requires attention and no escalator shutdown is warranted and indicative of the at least one tooth being incorrectly positioned such that the escalator shutdown is warranted.

In accordance with additional or alternative embodiments, the detection system is further configured to execute the escalator shutdown.

According to an aspect of the disclosure, an escalator system is provided and includes a combplate including teeth, a moving step including grooves and being drivable to pass by the combplate at a step-combplate interface at which, when each tooth is correctly positioned, each tooth passes through a corresponding groove and a detection system. The detection system includes an emitter and receiver pair and is configured to determine whether a signal pattern, which is derived from communications of the emitter and receiver pair and which is partially reflective of conditions of the teeth, is one of a baseline signal pattern, which indicates that each tooth is correctly positioned, and a divergent signal pattern, which diverges from the baseline signal pattern and indicates that at least one tooth is incorrectly positioned.

In accordance with additional or alternative embodiments, the signal pattern is a sonic pattern.

In accordance with additional or alternative embodiments, the emitter and receiver pair includes an emitter and a receiver arranged proximate to a plane of the step-combplate interface.

In accordance with additional or alternative embodiments, the emitter and receiver pair includes an ultrasonic emitter.

In accordance with additional or alternative embodiments, the emitter and receiver pair comprises an emitter and a receiver respectively connected to outermost teeth of the combplate.

In accordance with additional or alternative embodiments, the divergent signal pattern diverges from the baseline signal pattern in at least one of frequency, amplitude and shape.

In accordance with additional or alternative embodiments, the detection system is further configured to determine whether the divergent signal pattern is one of indicative of the at least one tooth being incorrectly positioned such that the combplate requires attention and no escalator shutdown is warranted and indicative of the at least one tooth being incorrectly positioned such that the escalator shutdown is warranted.

In accordance with additional or alternative embodiments, the detection system is further configured to execute the escalator shutdown.

According to an aspect of the disclosure, a method of operating a detection system of an escalator system in which a moving step including grooves passes by a combplate at a step-combplate interface at which, when each tooth of the combplate is correctly positioned, each tooth passes through a corresponding groove, is provided. The method includes executing communications of an emitter and receiver pair, deriving a signal pattern from the communications of the emitter and receiver pair with the signal pattern being partially reflective of conditions of the teeth and determining whether the signal pattern is one of a baseline signal pattern, which indicates that each tooth is correctly positioned and a divergent signal pattern, which diverges from the baseline signal pattern and indicates that at least one tooth is incorrectly positioned.

In accordance with additional or alternative embodiments, the determining includes determining whether the divergent signal pattern diverges from the baseline signal pattern in at least one of frequency, amplitude and shape.

In accordance with additional or alternative embodiments, the determining includes determining whether the divergent signal pattern is one of indicative of the at least one tooth being incorrectly positioned such that the combplate requires attention and no escalator shutdown is warranted and indicative of the at least one tooth being incorrectly positioned such that the escalator shutdown is warranted.

In accordance with additional or alternative embodiments, the method further includes executing the escalator shutdown.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an escalator system in accordance with embodiments;

FIG. 2 is an enlarged perspective view of landing of the escalator system of FIG. 1 in accordance with embodiments;

FIG. 3 is a schematic illustration of components of a detection system for use with an escalator system in accordance with embodiments;

FIG. 4 are graphical depictions of baseline and divergent signal patterns of the detection system of FIG. 3 in accordance with embodiments;

FIG. 5 is a schematic illustration of a tooth of a combplate that is out of position but does not necessarily require escalator shutdown in accordance with embodiments;

FIG. 6 is a schematic illustration of a tooth of a combplate that is out of position and may require escalator shutdown in accordance with embodiments; and

FIG. 7 is a flow diagram illustrating a method of operating a detection system of an escalator system in accordance with embodiments.

### DETAILED DESCRIPTION

In escalator technology, the combplate is a safety item that ensures that parts of passengers' bodies or other material does not get caught in the transition between the moving step and the floor plate. A main factor for the combplate to be effective, is that all the teeth of the combplate are in good condition and that the comb is correctly attached to the combplate. Currently there is no system that monitors the condition of the teeth of the combplate or the combplate as a whole besides manual inspection. Such inspections are totally dependent on an analysis by the corresponding technician.

Thus, as will be described below, a method and system are provided to monitor a condition of teeth of a combplate of an escalator or a moving walkway. An emitter, such as an ultrasound emitter or another similar emitter, is connected to the side of the combplate and a receiver for the emitter is connected to the opposite side of the combplate. A signal emitted by the emitter and received by the receiver will have a certain signal pattern, which will be associated with and reflective of a condition of the teeth of the combplate. When the teeth of the combplate are in good condition, the signal pattern will have a corresponding baseline waveform that can be recognized by a processor. Conversely, when one or more of the teeth of the combplate are not in good condition (i.e., because it/they are bent), the signal pattern will diverge from the baseline waveform and the processor will recognize that this divergence is indicative of an issue that needs to be addressed, such as by shutting the escalator or walkway down.

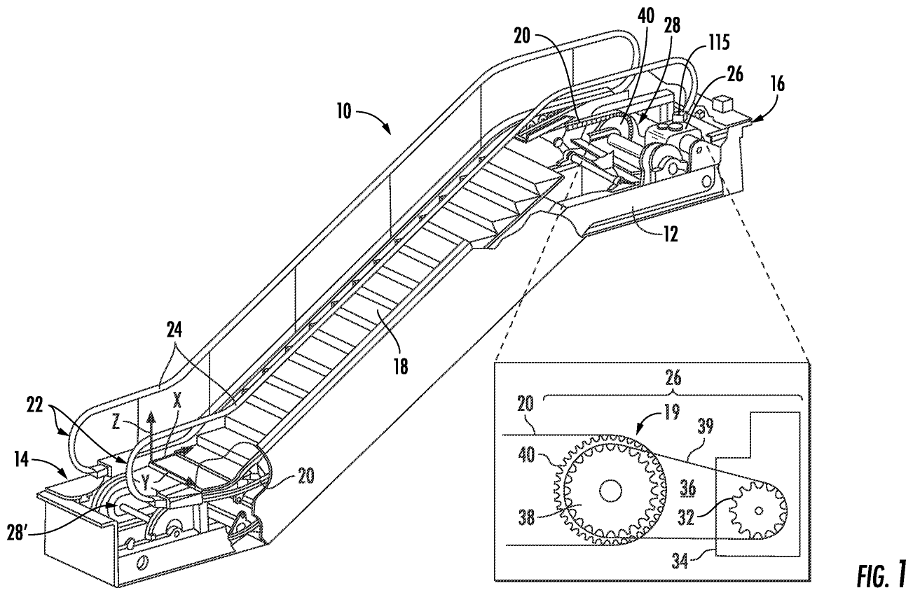

With reference to FIG. 1, an escalator 10 is provided. It should become apparent in the ensuing description that the invention is applicable to other passenger conveyor systems, such as moving walks. The escalator 10 generally includes a truss 12 extending between a lower landing 14 and an upper landing 16. A plurality of sequentially connected steps or tread plates 18 are connected to a step chain 20 and travel through a closed loop path within the truss 12. A pair of balustrades 22 are disposed on either side of the escalator 10, with each balustrade 22 including a moving handrail 24. A drive machine 26, or drive system, is typically located in a machine space 28 under the upper landing 16. An additional machine space 28′ can be located under the lower landing 14. The drive machine 26 is configured to drive the tread plates 18 and/or handrails 24 through the step chain 20. The drive machine 26 operates to move the tread plates 18 in a chosen direction at a desired speed under normal operating conditions.

The tread plates 18 make a 180 degree heading change in a turn-around area 19 located under the lower landing 14 and the upper landing 16. The tread plates 18 are pivotally attached to the step chain 20 and follow a closed loop path of the step chain 20, running from one landing to the other, and back again.

The drive machine 26 includes a first drive member 32, such as a motor output sheave, connected to a drive motor 34 through a belt reduction assembly 36 including a second drive member 38, such as an output sheave, driven by a tension member 39, such as an output belt. The first drive member 32 in some embodiments is a driving member, and the second drive member 38 is a driven member.

As used herein, the first drive member 32 and/or the second drive member 38, in various embodiments, may be any type of rotational device, such as a sheave, pulley, gear, wheel, sprocket, cog, pinion, etc. The tension member 39, in various embodiments, can be configured as a chain, belt, cable, ribbon, band, strip, or any other similar device that operatively connects two elements to provide a driving force from one element to another. For example, the tension member 39 may be any type of interconnecting member that extends between and operatively connects the first drive member 32 and a second drive member 38. In some embodiments, as shown in FIG. 1, the first drive member 32 and the second drive member may provide a belt reduction. For example, first drive member 32 may be approximately 75 mm (2.95 inches) in diameter while the second drive member 38 may be approximately 750 mm (29.53 inches) in diameter. The belt reduction, for example, allows the replacement of sheaves to change the speed for 50 or 60 Hz electrical supply power applications, or different step speeds. However, in other embodiments the second drive member 38 may be substantially similar to the first drive member 32.

As noted, the first drive member 32 is driven by drive motor 34 and thus is configured to drive the tension member 39 and the second drive member 38. In some embodiments the second drive member 38 may be an idle gear or similar device that is driven by the operative connection between the first drive member 32 and the second drive member 38 by means of tension member 39. The tension member 39 travels around a loop set by the first drive member 32 and the second drive member 38, which herein after may be referred to as a small loop. The small loop is provided for driving a larger loop which consists of the step chain 20, and is driven by an output sheave 40, for example. Under normal operating conditions, the tension member 39 and the step chain 20 move in unison, based upon the speed of movement of the first drive member 32 as driven by the drive motor 34.

The escalator 10 also includes a controller 115 that is in electronic communication with the drive motor 34. The controller 115 may be located, as shown, in the machine space 28 of the escalator 10 and is configured to control the operation of the escalator 10. For example, the controller 115 may provide drive signals to the drive motor 34 to control the acceleration, deceleration, stopping, etc. of the tread plates 18 through the step chain 20. The controller 115 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium

Although described herein as a particular escalator drive system and particular components, this is merely exemplary, and those of skill in the art will appreciate that other escalator system configurations may operate with the invention disclosed herein.

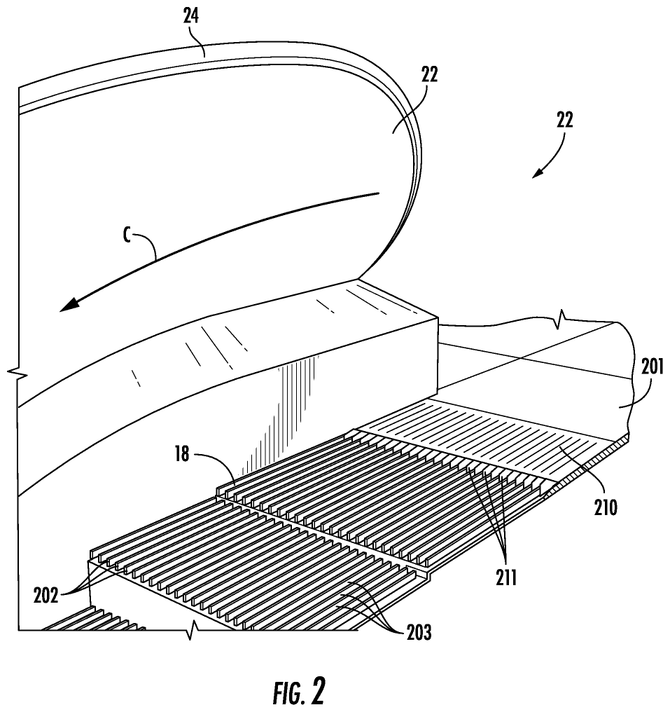

With reference to FIG. 2, the tread plates 18 of FIG. 1 can be provided as plurality of steps and the lower landing 14 and the upper landing 16 of FIG. 1 can include a floor plate 201. An upper surface of each of the steps (i.e., tread plates 18) can be provided with a plurality of alternating grooves 202 and cleats 203 extending in the conveyance direction C. A combplate 210 is arranged next to the floor plate 201 on the side of the floor plate 201 facing the steps. The combplate 210 includes a plurality of teeth 211 extending parallel to the conveyance direction C. The teeth 211 are arranged in a staggered relation with the cleats 203 of the steps and extend into the grooves 202.

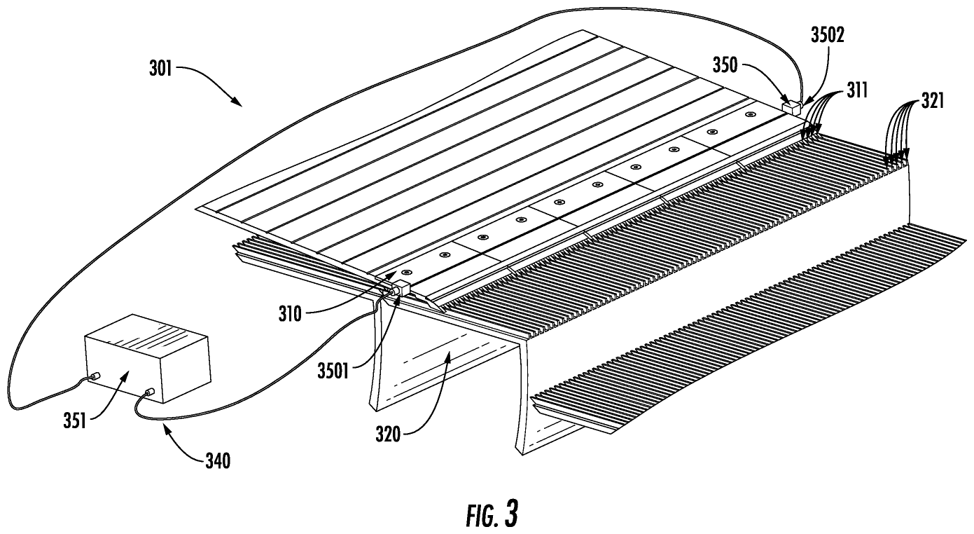

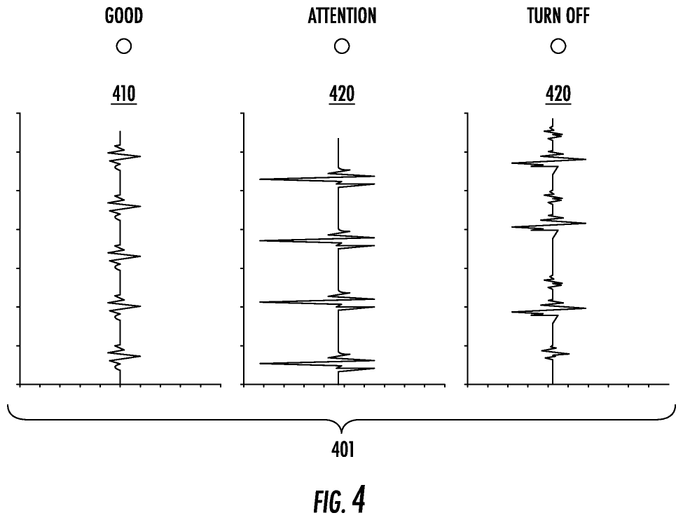

With reference to FIGS. 3 and 4, an escalator system 301 is provided. The escalator system 301 includes a combplate 310 and a moving step 320. The combplate 310 includes teeth 311. The moving step 320 includes grooves 321 and is drivable along a conveyance direction to pass by the combplate 310 at a step-combplate interface 330. At this step-combplate interface 330, each tooth 311 passes through a corresponding groove 321 when each tooth 311 is correctly positioned (i.e., when each tooth 311 is not bent, broken or loose). The escalator system 301 further includes a detection system 340 and the detection system 340 includes an emitter and receiver pair 350 and a processor 351, such as the controller 115 of FIG. 1 or a dedicated controller.

The detection system 340 is configured to determine whether a signal pattern 401 (see FIG. 4), which is derived from communications of the emitter and receiver pair 340 and which is partially reflective of conditions of the teeth 311, is one of a baseline signal pattern 410 and a divergent signal pattern 420. The baseline signal pattern 410 can be recognized by the detection system 340 (i.e., by the processor 351) as being indicative of a condition in which each tooth 311 of the combplate 310 is correctly positioned. The divergent signal pattern 420 can be recognized by the detection system 340 (i.e., by the processor 351) in that the divergent signal pattern 420 diverges from the baseline signal pattern 410 and as being indicative of conditions in which at least one tooth 311 of the combplate 310 is incorrectly positioned.

The processor 351 of the detection system is operably coupled to the emitter and receiver pair 340 and includes a processing unit, a networking unit by which the processing unit is communicative with the emitter and receiver pair 340 and with external devices and a memory. The memory has executable instructions stored thereon, which, when executed, cause the processing unit to operate as described herein. The following description will refer to the processor 351 generally.

In accordance with embodiments, the emitter and receiver pair 350 of the detection system 340 can include an emitter 3501 and a receiver 3502, both of which are coupled to and communicative with the processor 351. The emitter 3501 can be provided as an ultrasonic emitter and the receiver 3502 can be provided as a receiver that is configured to receive an ultrasonic signal from the emitter 3501. In these or other cases, the signal pattern 401 can be a sonic waveform pattern.

In accordance with further embodiments, the emitter 3501 and the receiver 3502 of the emitter and receiver pair 350 can be arranged at a location that is proximate to a plane P of the step-combplate interface 330. In these or other cases, as shown in FIG. 3, the emitter 3501 and the receiver 3502 can be respectively connected to outermost teeth 311 of the combplate 310.

With continued reference to FIGS. 3 and 4, the divergent signal pattern 420 can diverge from the baseline signal pattern 410 in at least one or more of a frequency, an amplitude and a shape or waveform.

During normal operations when the escalator system 301 is running and each tooth 311 of the combplate 310 is correctly positioned (i.e., when each tooth 311 is not bent, broken or loose), the emitter 3501 periodically sends a signal, such as an ultrasonic signal, to the receiver 3502. Since each tooth 311 is correctly positioned and passes through the corresponding groove 321, the passage of the moving step 320 by the complete 310 at the step-combplate interface 330 tends to generate a particular and predictable range of sounds. These sounds may or may not interact with the ultrasonic signal, such as by interference or resonance, whereby the signal that is ultimately received by the receiver 3502 will tend towards regularity and thus can be regarded as the baseline signal pattern 410. The processor 351 can be trained to recognize the baseline signal pattern 410.

In cases in which at least one tooth 311 is not correctly positioned, the passage of the moving step 320 by the complete 310 at the step-combplate interface 330 will tend to generate a unique range of sounds that depend on various factors, such as a number of incorrectly positioned teeth 311, a nature of the incorrect positioning of the teeth 311 and the degree to which incorrectly positioned teeth 311 are out of their correct position. These unique sounds will interact with the ultrasonic signal, such as by unique interference or resonance patterns, whereby the signal that is ultimately received by the receiver 3502 will diverge from the baseline signal pattern 410 in the at least one or more of the frequency, the amplitude and the shape or waveform. The processor 351 can be trained to thus recognize this signal as the divergent signal pattern 420.

With reference to FIG. 5, the divergence of the diverging signal pattern 420 from the baseline signal pattern 410 can be read by the processor 351 as being indicative of at least one tooth 311 being incorrectly positioned to such an extent that the combplate 310 requires attention but no escalator shutdown is warranted. An example of this instance is illustrated in FIG. 5 which depicts a tooth 311 being slightly offset from its normal angle. The offset tooth 311 gently grinds against the wall of the groove 321 as the moving step 320 passes by the combplate 310 at the step-combplate interface 330 and generates a persistent grinding sound that may or may not interact with the ultrasonic signal as described above.

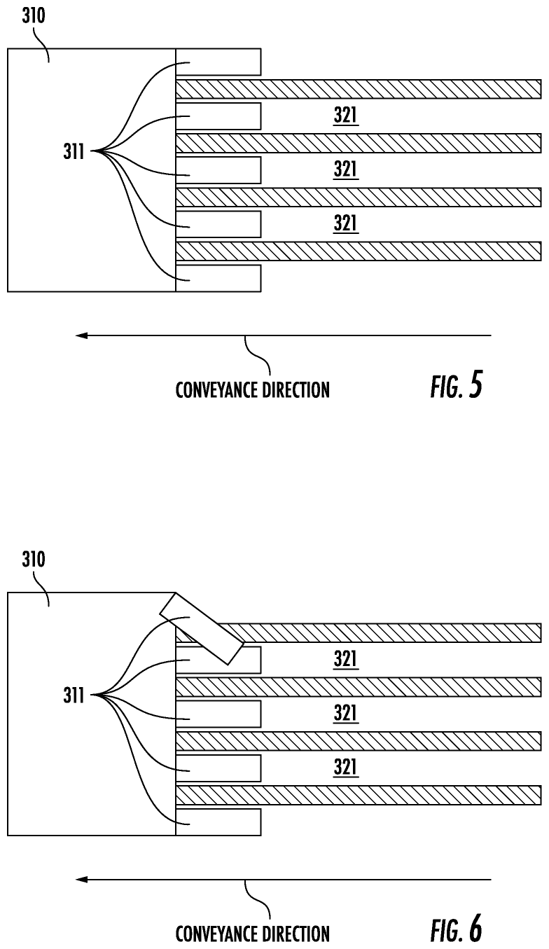

With reference to FIG. 6, the divergence of the diverging signal pattern 420 from the baseline signal pattern 410 can be read by the processor 351 as being indicative of at least one tooth 311 being incorrectly positioned to such an extent that the escalator shutdown is warranted. An example of this instance is illustrated in FIG. 5 which depicts a tooth 311 being loose. The loose tooth 311 bounces about as the moving step 320 passes by the combplate 310 at the step-combplate interface 330 and generates a somewhat randomized sound wave that interacts with the ultrasonic signal as described above. In cases in which the divergence of the diverging signal pattern 420 can be read as being indicative of at least one tooth 311 being incorrectly positioned to such an extent that the escalator shutdown is warranted, the processor 351 can be further configured to execute the escalator shutdown.

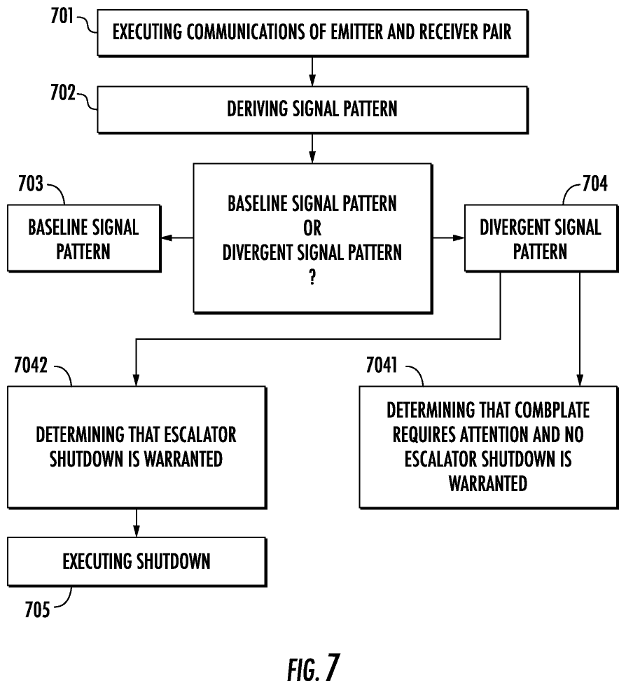

With reference back to FIGS. 3 and 4 and with additional reference to FIG. 7, a method of operating a detection system, such as the detection system 340 described above, is provided. The method includes executing communications of an emitter and receiver pair 350 (block 701) and deriving a signal pattern 401 from the communications of the emitter and receiver pair 350 with the signal pattern 401 being partially reflective of conditions of the teeth 311 (block 702). The method further includes determining whether the signal pattern is one of a baseline signal pattern 410 (block 703), which indicates that each tooth 311 is correctly positioned, and a divergent signal pattern 420 (block 704), which diverges from the baseline signal pattern 410 in at least one of a frequency, an amplitude and a shape or waveform and thus indicates that at least one tooth 311 is incorrectly positioned. The determining of block 704 can further include determining whether the divergent signal pattern 420 is one of indicative of the at least one tooth being incorrectly positioned such that the combplate requires attention and no escalator shutdown is warranted (block 7041) and indicative of the at least one tooth being incorrectly positioned such that the escalator shutdown is warranted (block 7042). In an event that the divergent signal pattern 420 is determined in block 7042 to be incorrectly positioned such that the escalator shutdown is warranted, the method can further include executing the escalator shutdown (block 705).

Technical effects and benefits of the present disclosure are the provision of a detection system for use with an escalator system to detect teeth of a combplate that are out of position, loose, bent, broken, etc. With this detection system, in addition to increased safety, productivity gains are obtained due to the possibility of increased time between manual inspections by a technician.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An escalator system, comprising:
a combplate comprising teeth;
a moving step comprising grooves and being drivable to pass by the combplate at a step-combplate interface at which, when each tooth is correctly positioned, each tooth passes through a corresponding groove; and
a detection system comprising an emitter and receiver pair and being configured to determine whether a signal pattern, which is derived from communications of the emitter and receiver pair and which is partially reflective of conditions of the teeth, is indicative of at least one tooth being incorrectly positioned.

2. The escalator system according to claim 1, wherein the signal pattern is a sonic pattern.

3. The escalator system according to claim 1, wherein the emitter and receiver pair comprises an emitter and a receiver arranged proximate to a plane of the step-combplate interface.

4. The escalator system according to claim 1, wherein the emitter and receiver pair comprises an ultrasonic emitter.

5. The escalator system according to claim 1, wherein the emitter and receiver pair comprises an emitter and a receiver respectively connected to outermost teeth of the combplate.

6. The escalator system according to claim 1, wherein at least one of a frequency, an amplitude and a shape of the signal pattern is indicative of the at least one tooth being incorrectly positioned.

7. The escalator system according to claim 1, wherein the detection system is further configured to determine whether the signal pattern is one of:
indicative of the at least one tooth being incorrectly positioned such that the combplate requires attention and no escalator shutdown is warranted, and
indicative of the at least one tooth being incorrectly positioned such that the escalator shutdown is warranted.

8. The escalator system according to claim 7, wherein the detection system is further configured to execute the escalator shutdown.

9. An escalator system, comprising:
a combplate comprising teeth;
a moving step comprising grooves and being drivable to pass by the combplate at a step-combplate interface at which, when each tooth is correctly positioned, each tooth passes through a corresponding groove; and
a detection system comprising an emitter and receiver pair and being configured to determine whether a signal pattern, which is derived from communications of the emitter and receiver pair and which is partially reflective of conditions of the teeth, is one of:
a baseline signal pattern, which indicates that each tooth is correctly positioned, and
a divergent signal pattern, which diverges from the baseline signal pattern and indicates that at least one tooth is incorrectly positioned.

10. The escalator system according to claim 9, wherein the signal pattern is a sonic pattern.

11. The escalator system according to claim 9, wherein the emitter and receiver pair comprises an emitter and a receiver arranged proximate to a plane of the step-combplate interface.

12. The escalator system according to claim 9, wherein the emitter and receiver pair comprises an ultrasonic emitter.

13. The escalator system according to claim 9, wherein the emitter and receiver pair comprises an emitter and a receiver respectively connected to outermost teeth of the combplate.

14. The escalator system according to claim 9, wherein the divergent signal pattern diverges from the baseline signal pattern in at least one of frequency, amplitude and shape.

15. The escalator system according to claim 9, wherein the detection system is further configured to determine whether the divergent signal pattern is one of:
indicative of the at least one tooth being incorrectly positioned such that the combplate requires attention and no escalator shutdown is warranted, and
indicative of the at least one tooth being incorrectly positioned such that the escalator shutdown is warranted.

16. The escalator system according to claim 15, wherein the detection system is further configured to execute the escalator shutdown.

17. A method of operating a detection system of an escalator system in which a moving step comprising grooves passes by a combplate at a step-combplate interface at which, when each tooth of the combplate is correctly positioned, each tooth passes through a corresponding groove, the method comprising:
executing communications of an emitter and receiver pair;
deriving a signal pattern from the communications of the emitter and receiver pair with the signal pattern being partially reflective of conditions of the teeth; and
determining whether the signal pattern is one of:
a baseline signal pattern, which indicates that each tooth is correctly positioned, and
a divergent signal pattern, which diverges from the baseline signal pattern and indicates that at least one tooth is incorrectly positioned.

18. The method according to claim 17, wherein the determining comprises determining whether the divergent signal pattern diverges from the baseline signal pattern in at least one of frequency, amplitude and shape.

19. The method according to claim 17, wherein the determining comprises determining whether the divergent signal pattern is one of:
indicative of the at least one tooth being incorrectly positioned such that the combplate requires attention and no escalator shutdown is warranted, and
indicative of the at least one tooth being incorrectly positioned such that the escalator shutdown is warranted.

20. The method according to claim 19, further comprising executing the escalator shutdown.
